(19) United States
(12) Patent Application Publication
(10) Pub. No.: US 2012/0086919 A1
(43) Pub. Date: Apr. 12, 2012

(54) COOLING DEVICE AND PROJECTOR COMPRISING THE SAME

(75) Inventors: Chia-Jui LIN, Taoyuan Hsien (TW); Hsiu-Ming CHANG, Taoyuan Hsien (TW)

(73) Assignee: DELTA ELECTRONICS, INC., Taoyuan Hsien (TW)

(21) Appl. No.: 13/167,981

(22) Filed: Jun. 24, 2011

(30) Foreign Application Priority Data
Oct. 12, 2010 (TW) 099134709

(51) Int. Cl. G03B 21/16

(52) U.S. Cl. 353/61

(57) ABSTRACT

A cooling device and a projector comprising the same are provided. The projector comprises a light source. The cooling device is disposed adjacent to the light source for cooling a bulb of the light source. The cooling device comprises a blower and a guiding device. The blower is used to generate an airflow towards the bulb. The guiding device is disposed adjacent to the blower and comprises a peripheral edge and a flapper. The peripheral edge defines an outlet for the airflow to pass therethrough. The flapper moves along a direction of gravity to partially cover the outlet to force the airflow to flow towards an end of the bulb away from the direction of gravity.

This application claims the benefit of the priority based on Taiwan Patent Application No. 099134709 filed on Oct. 12, 2010, the disclosure of which is incorporated herein by reference in its entirety.

### CROSS-REFERENCES TO RELATED APPLICATIONS

Not applicable.

### BACKGROUND OF THE INVENTION

1. Field of the Invention

The present invention provides a cooling device, and more particularly, to a cooling device for use in a projector to cool a bulb of a light source.

2. Descriptions of the Related Art

In reference to FIG. 1A, in conventional projector 1, high temperatures are generated during the operation of a bulb 20 which causes damage to the bulb 20 and/or other internal components. Therefore, the projector 1 must be provided with a cooling device 30 therein to lower the temperature of the bulb 20 during the operation of the projector 1. In detail, the cooling device 30 comprises a blower 31 and a guiding device 32. The blower 31 generates an airflow 311 that blows toward the bulb 20 via an outlet 321 of the guiding device 32. Thereby, the high temperature generated by the bulb 20 is lowered.

FIG. 1B depicts a case in which the outlet 321 of the guiding device 32 is disposed on the bulb 20. In detail, the gas for light emission in the bulb 20 is more concentrated in the upper portion 20a of the bulb 20, so when a high temperature is generated during the operation of the bulb 20, the upper portion 20a of the bulb 20 has a first temperature higher than the second temperature of the lower portion 20b of the bulb 20. When the airflow 311 generated by the blower 31 blows toward the bulb 20 via the outlet 321 of the guiding device 32, the airflow 311 blows towards both the upper portion 20a and lower portion 20b of the bulb 20 simultaneously. Even though the airflow 311 can lower the operating temperature of the bulb 20, the difference between the first temperature of the upper portion 20a and the second temperature of the lower portion 20b cannot be reduced. Consequently, a large difference in temperature between the upper portion 20a and the lower portion 20b will decrease the service life of the bulb 20.

Therefore, as shown in FIG. 2A, according to another conventional technology, a fixed baffle 322 is disposed on the lower portion of the outlet 321 of the guiding device 32 so that the airflow 311 only blows towards the upper portion 20a of the bulb 20. Thus, airflow 311 does not get to the lower portion 20b of the bulb 20. Thereby, the difference in temperature between the upper portion 20a and the lower portion 20b is effectively reduced and thus the service life of the bulb 20 is prolonged.

As shown in FIG. 2B, when the projector 1 is used upside down (e.g., hung upside down from a ceiling), the bulb 20 has a temperature distribution similar to what is described above: the upper portion 20a of the bulb 20 has a first temperature higher than a second temperature of the lower portion 20b of the bulb 20. However, it shall be noted herein that, due to the upside-down orientation, the fixed baffle 322 of the guiding device 32 is now located at the upper portion of the outlet 321; therefore, the fixed baffle 322 will guide the airflow 311 towards the lower portion 20b of the bulb 20 to further lower the second temperature of the lower portion 20b which is already lower than the first temperature of the upper portion 20a. Consequently, the difference in temperature between the upper portion 20a and the lower portion 20b is actually larger than the difference in temperature before the fixed baffle 322 is provided, and this further shortens the service life of the bulb 20 significantly.

In view of this, there is an urgent need in the art to provide a solution to effectively control the airflow direction of the cooling device such that the difference between the first temperature of the upper portion of the bulb and the second temperature of the lower portion of the bulb can be minimized regardless of the usage status of the projector.

### SUMMARY OF THE INVENTION

An objective of the present invention is to provide a cooling device and a projector using the cooling device. The cooling device is able to minimize the difference in temperature between an upper portion of a bulb and a lower portion of the bulb in various positioning statuses to prolong the service life of the bulb.

To achieve the aforesaid objective, the projector of the present invention comprises a light source with a bulb, and a cooling device. The cooling device is disposed adjacent to the light source to cool the bulb. The cooling device comprises a blower and a guiding device. The blower generates an airflow towards the bulb of the projector. The guiding device is disposed adjacent to the blower, and comprises a peripheral edge and a flapper. The peripheral edge defines an outlet for the airflow to pass therethrough. The flapper moves along with the direction of gravity utilized to partially cover the outlet. By using the flapper to partially cover the outlet, the airflow flows towards an end of the bulb away from the direction of gravity.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic top view of a conventional projector;

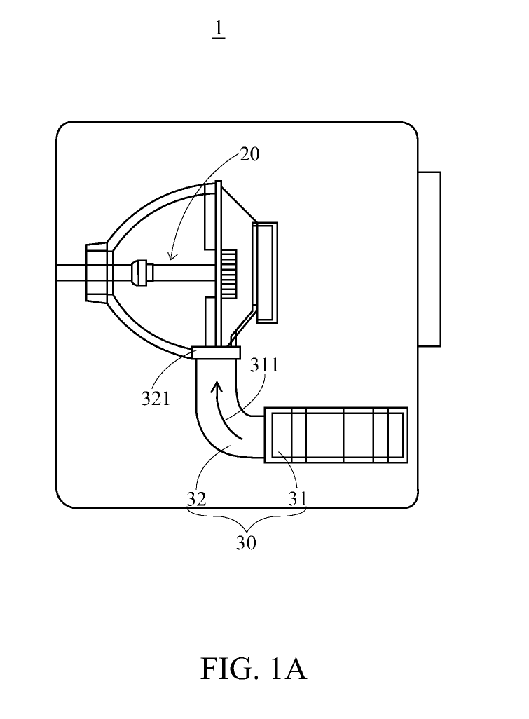

FIG. 1B is a schematic side view of a conventional bulb and a conventional cooling device;

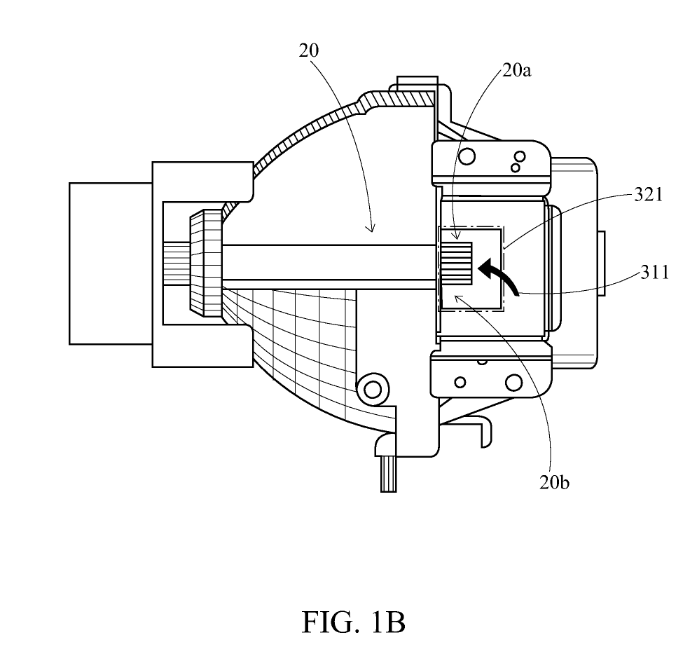

FIG. 2A is a schematic view showing an airflow of a bulb and a cooling device when another conventional projector is placed upright;

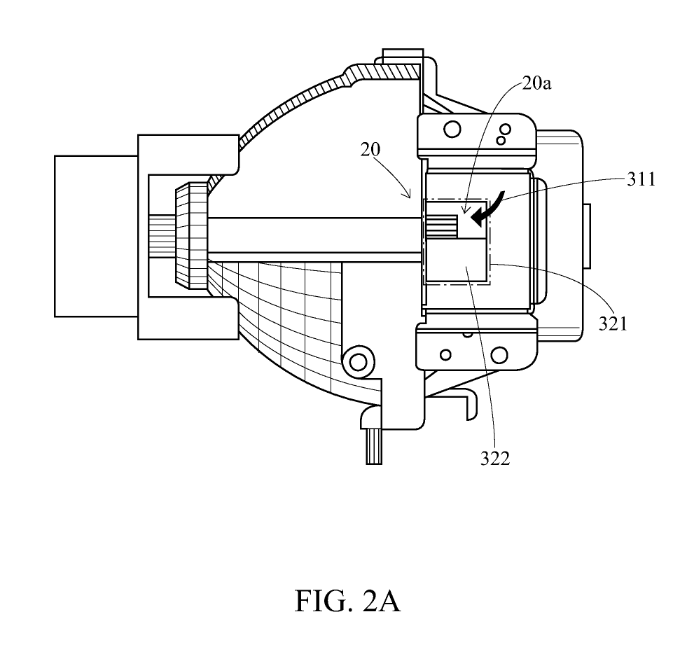

FIG. 2B is a schematic view showing the airflow of the bulb and the cooling device when the conventional projector shown in FIG. 2A is placed upside down;

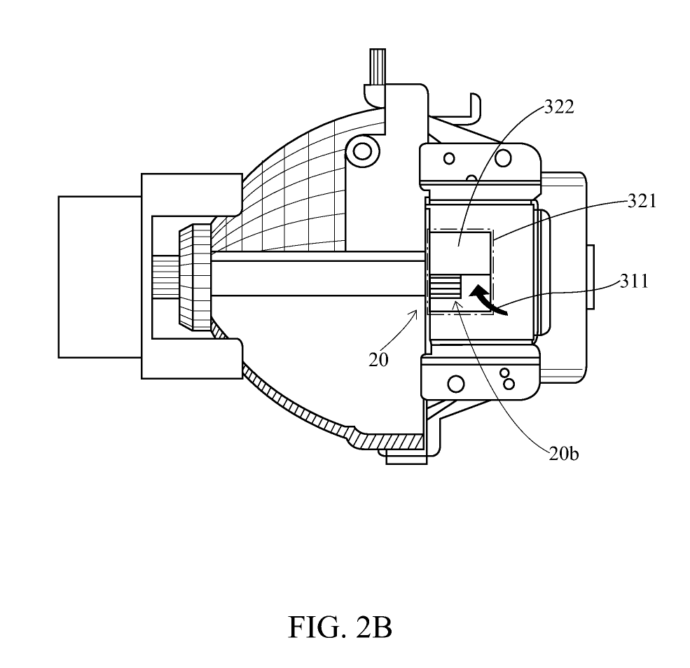

FIG. 3 is a schematic top view of a projector of the present invention;

FIG. 4 is a schematic view of a flapper of a cooling device according to the first embodiment of the present invention;

FIG. 5A is a schematic view showing a case in which the cooling device according to the first embodiment of the present invention is placed upright;

FIG. 5B is a schematic view showing a case in which the cooling device according to the first embodiment of the present invention is placed upside down;

FIG. 6 is a schematic view of a flapper of a cooling device according to the second embodiment of the present invention;

FIG. 7A is a schematic view showing a case in which the cooling device according to the second embodiment of the present invention is placed upright; and

FIG. 7B is a schematic view showing a case in which the cooling device according to the second embodiment of the present invention is placed upside down.

### DESCRIPTION OF THE PREFERRED EMBODIMENT

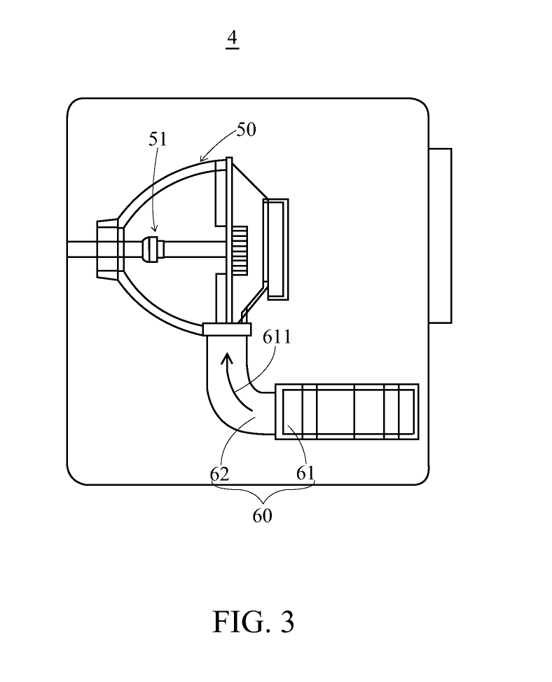

FIG. 3 illustrates the top view of a projector 4 of the present invention. The projector 4 comprises a light source 50 and a cooling device 60. The light source 50 has a bulb 51. The cooling device 60 is disposed adjacent to the light source 50 to cool the bulb 51. The cooling device 60 comprises a blower 61 and a guiding device 62. The blower 61 generates airflow 611 towards the bulb 51. The guiding device 62 is disposed adjacent to the blower 61.

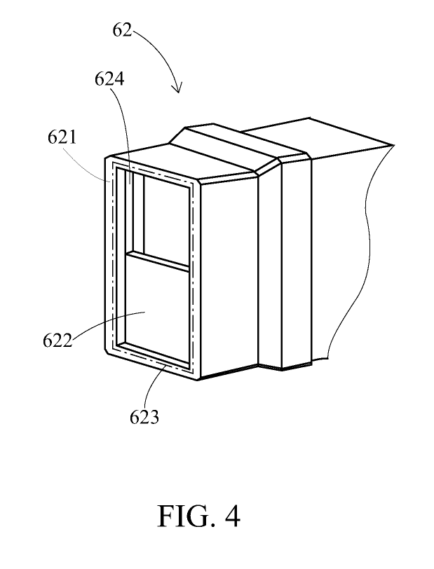

The first example of the guiding device 62 of the cooling device 60 of the present invention is shown in FIG. 4. In detail, the guiding device 62 comprises a peripheral edge 621, a flapper 622 and a slot 624. The peripheral edge 621 defines an outlet 623 for the airflow 611 to pass therethrough. The flapper 622 is slidably disposed in the slot 624 and moves in the direction of gravity to partially cover the outlet 623. Therefore, by using the flapper 622 to partially cover the outlet 623, the airflow 611 flows towards the end of the bulb 51 away from the direction of gravity.

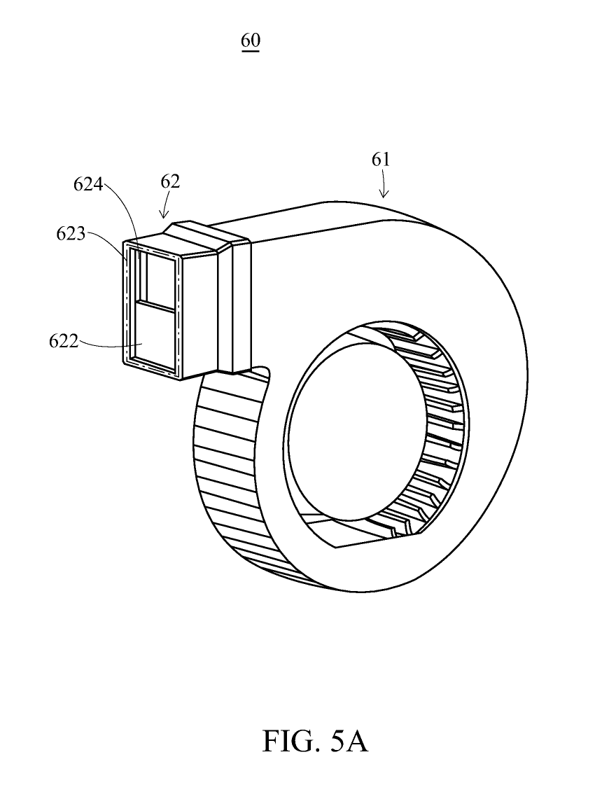

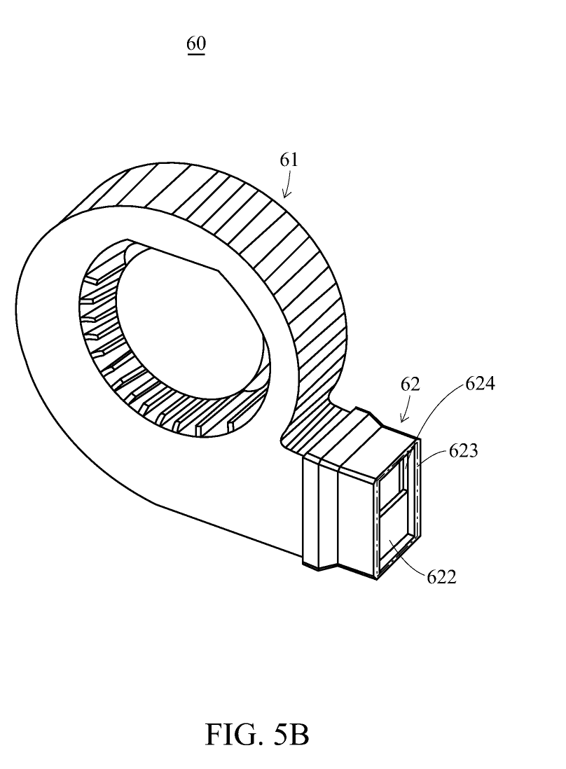

As shown in FIG. 5A, a first embodiment of the cooling device 60 of the present invention is formed by combining the blower 61 with the guiding device 62 shown in FIG. 4. When the projector 4 is placed upright, the flapper 622 slides downwards along the gravity direction by the gravity to partially cover a lower portion of the outlet 623; as a result, the airflow 611 only blows towards the upper end of the bulb 51 away from the gravity direction. On the other hand, when the projector 4 is placed upside down as shown in FIG. 5B, the flapper 622 slides along the slot 624 in the direction of gravity to partially cover the lower portion of the outlet 623 again; as a result, the airflow 611 still flows towards the upper end of the bulb 51 away from the direction of gravity.

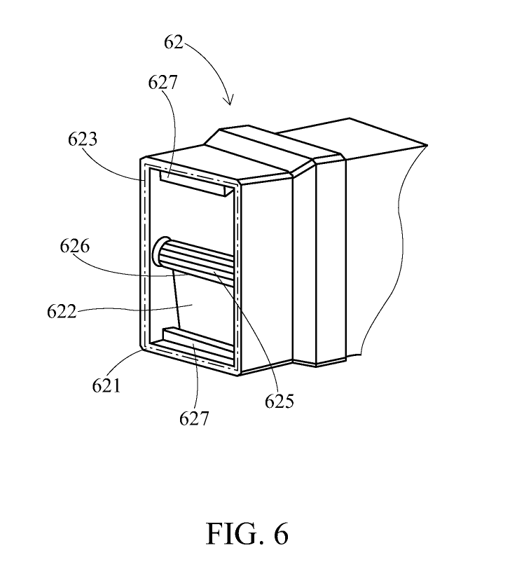

A second example of the guiding device 62 of the cooling device 60 of the present invention is shown in FIG. 6. Similarly, the guiding device 62 comprises a peripheral edge 621 and a flapper 622. The peripheral edge 621 defines an outlet 623 for the airflow 611 to pass therethrough. The second example is different from the first example in that the peripheral edge 621 comprises a pivot 625 and the flapper 622 has a lateral edge 626 thereof jointed to the pivot 625 to swing around the pivot 625 towards the direction of gravity to partially cover the outlet 623. In the second example, the peripheral edge 621 further comprises two bumps 627 disposed on two opposite ends of the peripheral edge 621 respectively so that when the flapper 622 swings to the opposite ends, the bumps 627 stop the flapper 622; therefore, the flapper 622 of the second example always swings with an angle no greater than 180 degrees. Thereby, the swaying of the flapper 622 due to the airflow 611, which would otherwise make it impossible to effectively cover the lower portion of the outlet 623, can be avoided. Meanwhile, the bumps 627 forces the flapper 622 to include a vertical angle to prevent the flapper 622 from smoothly swinging towards the lower portion of the outlet 623 in response to the change in the positioning direction as its barycenter just passes through the pivot 625.

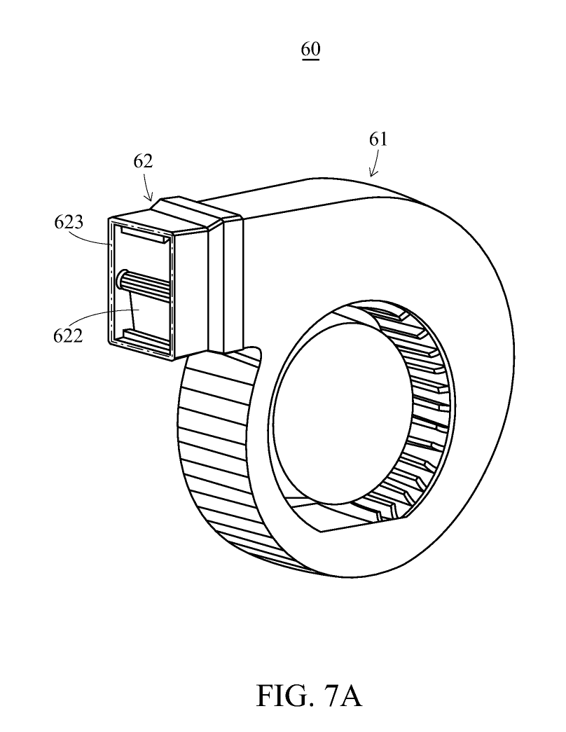

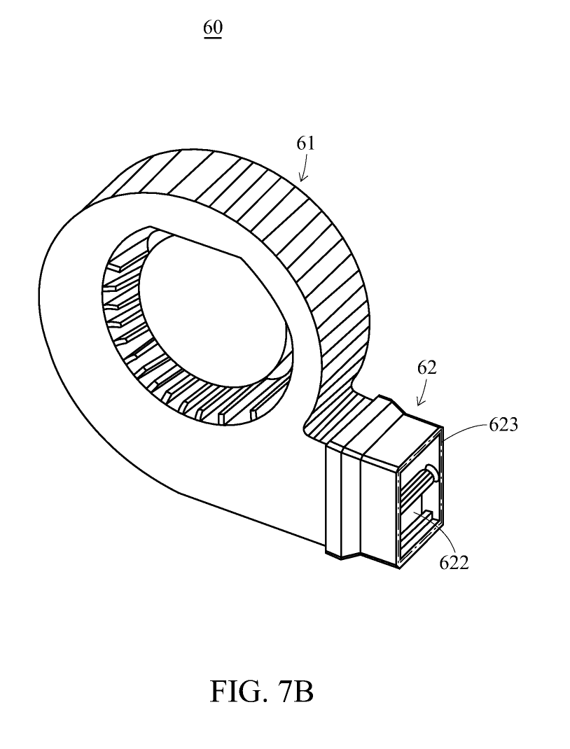

As shown in FIG. 7A, the second embodiment of the cooling device 60 of the present invention is formed by combining the blower 61 with the guiding device 62 shown in FIG. 6. When the projector 4 is placed upright, the flapper 622 swings around the pivot 625 towards the direction of gravity to partially cover the lower portion of the outlet 623; as a result, the airflow 611 only blows towards the upper end of the bulb 51 away from the gravity direction. On the other hand, when the projector 4 is placed upside down as shown in FIG. 7B, the flapper 622 swings around the pivot 625 with gravity to partially cover the lower portion of the outlet 623 again; as a result, the airflow 611 still flows towards the upper end of the bulb 51 away from the direction of gravity.

It shall be particularly appreciated that the blower 61 and the guiding device 62 of the cooling device 60 of the present invention may be combined with each other in the aforesaid manners and may also be integrally formed as will readily occur to those of ordinary skill in the art. The blower 61 and the guiding device 62 when integrally formed will deliver the same effect as what has been described above, and thus will not be further described herein.

According to the above descriptions, through the disposition of the flapper, the cooling device of the present invention can, in response to different positioning directions of the projector in different applications, enhance the heat dissipation of the end of the bulb away from the direction of gravity to reduce the difference in temperature between the upper portion of the bulb and the lower portion of the bulb, thereby effectively prolonging the service life of the bulb.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A cooling device for use in a projector, the projector comprising a light source, the cooling device being disposed adjacent to the light source for cooling a bulb of the light source, the cooling device comprising:
a blower for generating an airflow toward the bulb; and
a guiding device disposed adjacent to the blower, comprising:
a peripheral edge, defining an outlet for the airflow to pass therethrough; and
a flapper, moving along a gravity direction by gravity to partially cover the outlet;
wherein by using the flapper to partially cover the outlet, the airflow flows toward an end of the bulb away from the gravity direction.

2. The cooling device as claimed in claim 1, wherein the peripheral edge comprises a slot, and the flapper is slidably disposed in the slot to partially cover the outlet.

3. The cooling device as claimed in claim 2, wherein the airflow flows toward an upper end of the bulb.

4. The cooling device as claimed in claim 1, wherein the peripheral edge comprises a pivot, and the flapper has a lateral edge thereof jointed to the pivot to swing around the pivot and partially cover the outlet.

5. The cooling device as claimed in claim 4, wherein the airflow flows toward an upper end of the bulb.

6. The cooling device as claimed in claim 5, wherein the flapper swings with an angle less than or equal to 180 degree.

7. The cooling device as claimed in claim 6, wherein the peripheral edge further comprises two bumps disposed on two opposite ends of the peripheral edge respectively so that when the flapper swings to the opposite ends, the bumps stop the flapper.

8. The cooling device as claimed in claim 1, wherein the blower is integrated with the guiding device.

9. A projector, comprising:
a light source with a bulb; and
a cooling device disposed adjacent to the light source for cooling the bulb, comprising:
a blower for generating an airflow toward the bulb; and
a guiding device disposed adjacent to the blower, the guiding device comprising a peripheral edge and a flapper, the peripheral edge defining an outlet for the airflow to pass therethrough, and the flapper moving along a gravity direction by gravity to partially cover the outlet; wherein by using the flapper to partially cover the outlet, the airflow flows toward an end of the bulb away from the gravity direction.

10. The projector as claimed in claim 9, wherein the peripheral edge comprises a slot, and the flapper is slidably disposed in the slot to partially cover the outlet.

11. The projector as claimed in claim 10, wherein the airflow flows toward an upper end of the bulb.

12. The projector as claimed in claim 9, wherein the peripheral edge comprises a pivot, and the flapper has a lateral edge thereof jointed to the pivot to swing around the pivot and partially cover the outlet.

13. The projector as claimed in claim 12, wherein the airflow flows toward an upper end of the bulb.

14. The projector as claimed in claim 13, wherein the flapper swings with an angle less than or equal to 180 degree.

15. The projector as claimed in claim 14, wherein the peripheral edge further comprises two bumps disposed on two opposite ends of the peripheral edge respectively so that when the flapper swings to the opposite ends, the bumps stop the flapper.

16. The projector as claimed in claim 9, wherein the blower is integrated with the guiding device.
